(19) United States
(12) Patent Application Publication
(10) Pub. No.: US 2012/0185265 A1
(43) Pub. Date: Jul. 19, 2012

(54) METHOD AND SYSTEM FOR PATIENT PREPARATION FOR A HEALTH CARE FACILITY VISIT

(75) Inventor: Devinder Singh Kochhar, Ann Arbor, MI (US)

(73) Assignee: FORD GLOBAL TECHNOLOGIES, LLC, Dearborn, MI (US)

(21) Appl. No.: 13/009,120

(22) Filed: Jan. 19, 2011

(51) Int. Cl. G06Q 50/00; G06Q 10/00

(52) U.S. Cl. 705/2

(57) ABSTRACT

In various embodiments, a vehicle user may prepare for a health care facility visit. Information identifying one or more health facilities may be received at a vehicle computer. Based on the health facility identifying information, data representing one or more electronic patient information records for the health facility may be received. The electronic patient information record(s) may be prepared based on vehicle user health information received at a vehicle computer. The electronic patient information record(s) may be stored and/or transmitted in response to vehicle-based event(s).

### BACKGROUND

1. Technical Field

Various embodiments relate to preparing a vehicle user for a visit to a health facility. In some embodiments, the vehicle user may prepare forms in a vehicle that are requested by the health facility to be completed and transmit the forms to the health facility prior to arrival. The health facility may be preselected by the user or identified based on a geographic location of the vehicle.

2. Background Art

There are various examples of tools for gathering and recording information about a person that may be used in preparation for an activity or event such as purchases, meetings, appointments, and the like.

One such example is U.S. Publication No. 2003/0028792 to Plow et al (“Plow”). Plow discloses a system and method for automatically inputting user data into Internet based electronic forms includes creating an autofill profile at a user computer. The autofill profile includes user information and is stored at the user computer. When electronic forms are encountered on the Internet, information from the autofill profile is used to automatically fill the input fields of the electronic form. The autofill profile is automatically updated with new user information each time an electronic form is submitted to a server if the form includes new information manually input by the user.

Another example is U.S. Publication No. 2002/0013788 to Pennell et al. (“Pennell”). Pennell discloses a method and apparatus allowing for entry of form data in a browser. A browser automation program executes on the user's computer and communicates with a browser program in order to determine when forms are encountered.

### SUMMARY

One aspect includes a computer-implemented method for preparing a vehicle user for a health care facility visit. The computer-implemented method includes receiving vehicle network data which defines vehicle-based events. Information identifying a health facility may also be received at a vehicle computer.

Based on the health facility identifying information, data representing one or more electronic patient information records for the health facility may be received at the vehicle computer. Further, in order to prepare the electronic patient information record(s), vehicle user health information may be received.

Based on the vehicle user health information, the electronic patient information record(s) may be prepared and transmitted to the health facility in response to the vehicle-based event(s) based on the vehicle network data.

In some embodiments, preparation instructions may be provided in the vehicle for preparing the electronic patient information record. These instructions may be provided in response to a user request for the instructions and presented in a spoken language.

In some embodiments, supplemental electronic patient information records may be presented in the vehicle and transmitted to a health facility if one or more electronic patient information record have been previously received by the health facility.

In another aspect, a computer program product embodied in a computer-readable medium for preparing a vehicle user for a health care facility visit may include instructions for receiving vehicle network data defining one or more vehicle-based events. The computer-program product may further include instructions for presenting one or more electronic patient information records for a health facility at the vehicle computer.

The computer-program product may further include instructions for receiving a vehicle user request for preparation instructions for one or more fields of the electronic patient information records. The computer-program product may also include instructions for receiving the preparation instructions for the field(s) based on the user request and further instructions for outputting the preparation instructions at a vehicle computer.

The computer-program product may include additional instructions for, upon outputting the preparation instructions, receiving vehicle user health information in order to prepare the field(s) of the electronic patient information record(s). Further instructions may be for storing the electronic patient information record(s) in response to one or more vehicle-based events based on the vehicle network data.

In some embodiments, the computer-program product may include further instructions for transmitting the electronic patient information record in response to the vehicle-based event(s). The vehicle-based events may include a key-on, key-off, one or more button presses, one or more inputs from a microphone, or a gear change.

In another aspect, a system may include a computer which is configured to receive vehicle network data that defines vehicle-based events. The computer may be further configured to receive a user selected health facility. Further, the computer may be configured to output information defining fields of a patient information record for the health facility.

The computer may also be configured to receive preparation instructions for a field and receive vehicle user information according to the preparation instructions. The computer may be configured to prepare the field based on the vehicle user information and, in response to the vehicle-based events, store the patient information record.

In some embodiments, the computer may be further configured to prepare the field automatically based on vehicle user information stored in memory.

These and other aspects will be better understood in view of the attached drawings and following detailed description of the invention.

### BRIEF DESCRIPTION OF THE DRAWINGS

The figures identified below are illustrative of some embodiments of the invention. The figures are not intended to be limiting of the invention recited in the appended claims. The embodiments, both as to their organization and manner of operation, together with further object and advantages thereof, may best be understood with reference to the following description, taken in connection with the accompanying drawings, in which:

FIG. 1 illustrates a block topology for a vehicle computing system;

FIG. 2 illustrates a registration process for a vehicle user/patient;

FIG. 3 illustrates a registration process for a health care facility;

FIG. 4 illustrates an in-vehicle process for preparing for a visit to a health care facility;

FIG. 5 illustrates the operation for providing forms to a vehicle user and receiving completed forms as part of the preparation process of FIG. 4;

FIG. 6 illustrates a process for preparing/updating a health profile by a health facility;

FIG. 7 illustrates an operation for providing form preparation assistance to a vehicle user during the process for preparing for a health facility visit; and

FIG. 8 illustrates a block topology of a remote system communicating with the vehicle computing system of FIG. 1 and used in the health facility visit preparation process.

### DETAILED DESCRIPTION

Often, patients may not come fully prepared to a health care facility such as a hospital, doctor's office, dentist and the like. Additionally, the health care facility may not have all the information pertinent to the patient including, but not limited to, the patient history. Accordingly, lack of adequate preparation on both sides can result in increased costs, wasted time and/or aggravation. Such negative consequences increase several fold particularly when trying to manage health facility visits with professional and personal obligations.

Preparing an individual before a visit can help reduce some of this aggravation. For example, many vehicles today come equipped with vehicle computers that are equipped with network connectivity capabilities. One such system is SYNC from the FORD MOTOR COMPANY. Accordingly, these capabilities can be leveraged so that a vehicle user (e.g., a driver and/or passenger) can prepare for a visit to a health care facility while, for example, driving to the appointment.

Detailed embodiments of the invention are disclosed herein. However, it is to be understood that the disclosed embodiments are merely exemplary of an invention that may be embodied in various and alternative forms. Therefore, specific functional details disclosed herein are not to be interpreted as limiting, but merely as a representative basis for the claims and/or as a representative basis for teaching one skilled in the art to variously employ the present invention.

The various embodiments described herein are provided in the context of health care services. However, the various embodiments can also be applied in other service environments where an individual and/or service entity may need to prepare before an appointment, meeting, or other like event. Preparation may include, but is not limited to, information gathering activities about an individual such as (and without limitation) form preparation and record retrieval (e.g., hardcopy and electronic).

It will be appreciated that the disclosure and arrangement of the figures is non-limiting. Accordingly, the disclosure and arrangement may be modified or re-arranged to best fit a particular implementation of the various embodiments of the invention.

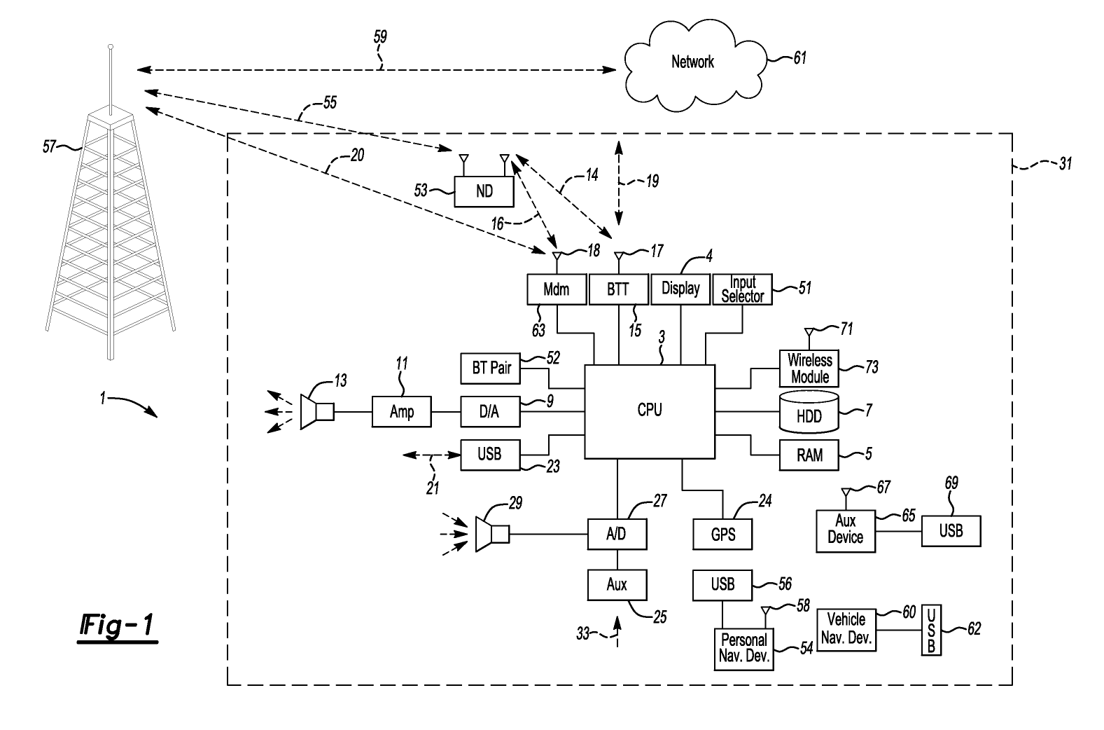

FIG. 1 illustrates an example block topology for a vehicle based computing system 1 (VCS) for a vehicle 31. An example of such a vehicle-based computing system 1 is the SYNC system manufactured by THE FORD MOTOR COMPANY. A vehicle enabled with a vehicle-based computing system may contain a visual front end interface 4 located in the vehicle. The user may also be able to interact with the interface if it is provided, for example, with a touch sensitive screen. In another illustrative embodiment, the interaction occurs through, button presses, audible speech and speech synthesis.

In the illustrative embodiment 1 shown in FIG. 1, a processor 3 controls at least some portion of the operation of the vehicle-based computing system. Provided within the vehicle, the processor allows onboard processing of commands and routines. Further, the processor is connected to both non-persistent 5 and persistent storage 7. In this illustrative embodiment, the non-persistent storage is random access memory (RAM) and the persistent storage is a hard disk drive (HDD) or flash memory.

The processor is also provided with a number of different inputs allowing the user to interface with the processor. In this illustrative embodiment, a microphone 29, an auxiliary input 25 (for input 33), a USB input 23, a GPS input 24 and a BLUETOOTH input 15 are all provided. An input selector 51 is also provided, to allow a user to swap between various inputs. Input to both the microphone and the auxiliary connector is converted from analog to digital by a converter 27 before being passed to the processor. Although not shown, numerous of the vehicle components and auxiliary components in communication with the VCS may use a vehicle network (such as, but not limited to, a CAN bus) to pass data to and from the VCS (or components thereof).

Outputs to the system can include, but are not limited to, a visual display 4 and a speaker 13 or stereo system output. The speaker is connected to an amplifier 11 and receives its signal from the processor 3 through a digital-to-analog converter 9. Output can also be made to a remote BLUETOOTH device such as PND 54 or a USB device such as vehicle navigation device 60 along the bi-directional data streams shown at 19 and 21 respectively.

In one illustrative embodiment, the system 1 uses the BLUETOOTH transceiver 15 to communicate 17 with a user's nomadic device 53 (e.g., cell phone, smart phone, PDA, or any other device having wireless remote network connectivity). The nomadic device can then be used to communicate 59 with a network 61 outside the vehicle 31 through, for example, communication 55 with a cellular tower 57. In some embodiments, tower 57 may be a WiFi access point.

Exemplary communication between the nomadic device and the BLUETOOTH transceiver is represented by signal 14.

Pairing a nomadic device 53 and the BLUETOOTH transceiver 15 can be instructed through a button 52 or similar input. Accordingly, the CPU is instructed that the onboard BLUETOOTH transceiver will be paired with a BLUETOOTH transceiver in a nomadic device.

Data may be communicated between CPU 3 and network 61 utilizing, for example, a data-plan, data over voice, or DTMF tones associated with nomadic device 53. Alternatively, it may be desirable to include an onboard modem 63 having antenna 18 in order to communicate 16 data between CPU 3 and network 61 over the voice band. The nomadic device 53 can then be used to communicate 59 with a network 61 outside the vehicle 31 through, for example, communication 55 with a cellular tower 57. In some embodiments, the modem 63 may establish communication 20 with the tower 57 for communicating with network 61. As a non-limiting example, modem 63 may be a USB cellular modem and communication 20 may be cellular communication.

In one illustrative embodiment, the processor is provided with an operating system including an API to communicate with modem application software. The modem application software may access an embedded module or firmware on the BLUETOOTH transceiver to complete wireless communication with a remote BLUETOOTH transceiver (such as that found in a nomadic device).

In another embodiment, nomadic device 53 includes a modem for voice band or broadband data communication. In the data-over-voice embodiment, a technique known as frequency division multiplexing may be implemented when the owner of the nomadic device can talk over the device while data is being transferred. At other times, when the owner is not using the device, the data transfer can use the whole bandwidth (300 Hz to 3.4 kHz in one example).

If the user has a data-plan associated with the nomadic device, it is possible that the data-plan allows for broad-band transmission and the system could use a much wider bandwidth (speeding up data transfer). In still another embodiment, nomadic device 53 is replaced with a cellular communication device (not shown) that is installed to vehicle 31. In yet another embodiment, the ND 53 may be a wireless local area network (LAN) device capable of communication over, for example (and without limitation), an 802.11g network (i.e., WiFi) or a WiMax network.

In one embodiment, incoming data can be passed through the nomadic device via a data-over-voice or data-plan, through the onboard BLUETOOTH transceiver and into the vehicle's internal processor 3. In the case of certain temporary data, for example, the data can be stored on the HDD or other storage media 7 until such time as the data is no longer needed.

Additional sources that may interface with the vehicle include a personal navigation device 54, having, for example, a USB connection 56 and/or an antenna 58, a vehicle navigation device 60 having a USB 62 or other connection, an onboard GPS device 24, or remote navigation system (not shown) having connectivity to network 61.

Further, the CPU could be in communication with a variety of other auxiliary devices 65. These devices can be connected through a wireless 67 or wired 69 connection. Auxiliary device 65 may include, but are not limited to, personal media players, wireless health devices, portable computers, and the like.

Also, or alternatively, the CPU could be connected to a vehicle based wireless router 73, using for example a WiFi 71 transceiver. This could allow the CPU to connect to remote networks in range of the local router 73.

A user may prepare for a visit to a health care facility using a software tool which may be offered by an automotive OEM. This software tool may be a software application that may be downloaded to the VCS 1 or the ND 53 or, in some embodiments, stored on a remote server and available to the user via a network 61 (such as the Internet). Alternatively, the VCS 1 may be programmed with logic enabling this service. In some embodiments, a vehicle owner may pay a subscription fee (e.g., with the automotive OEM) for the service.

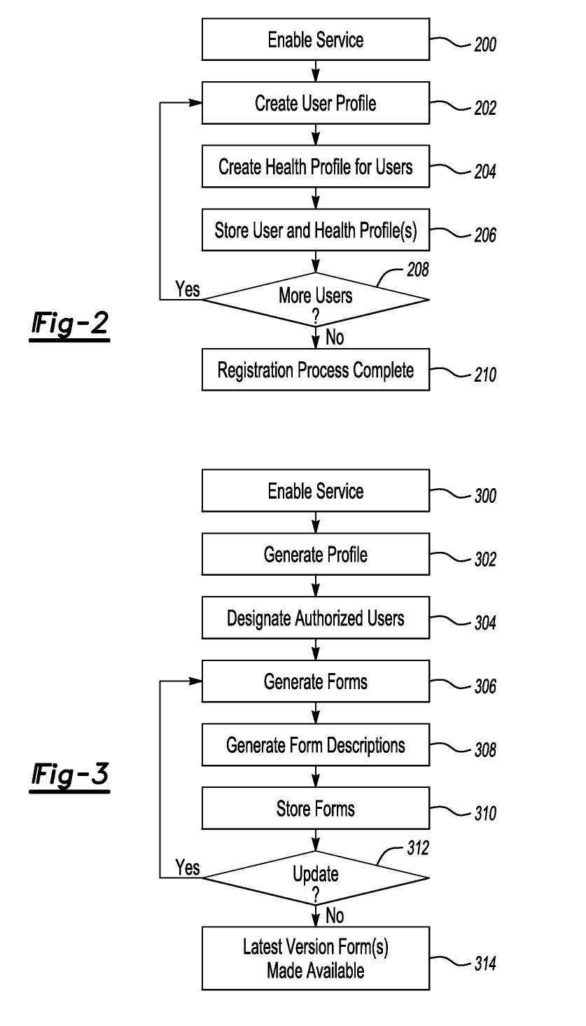

In any case, a user may participate in a registration process for using this service. In some embodiments, the registration process may be a web-based registration process (e.g., using a web browser and the Internet) which may occur during or after acquisition of the vehicle. FIG. 2 illustrates the user registration process for a vehicle owner and other users of the vehicle. The service may be enabled in the vehicle as described above (block 200). Once enabled, a user may create a user profile (block 202). This may include, but is not limited to, establishing user identification information (e.g., a username and password), providing the vehicle user's name, contact information, age and/or date of birth, gender, emergency contact(s), nationality, race, and other like information. In some embodiments, the user identification information may be a biometric identifier (e.g., a fingerprint, voice recognition, and the like). In some embodiments, the user profile may additionally include the type of vehicle and vehicle identification information.

A health profile may also be created for the user (block 204). The health profile may include health-related information about the user. This may include, but is not limited to, the vehicle user's health history (e.g., medical, psychological, dental, etc.), family health history, weight, present health conditions, current medication and medication history, primary care professional, and health insurance information.

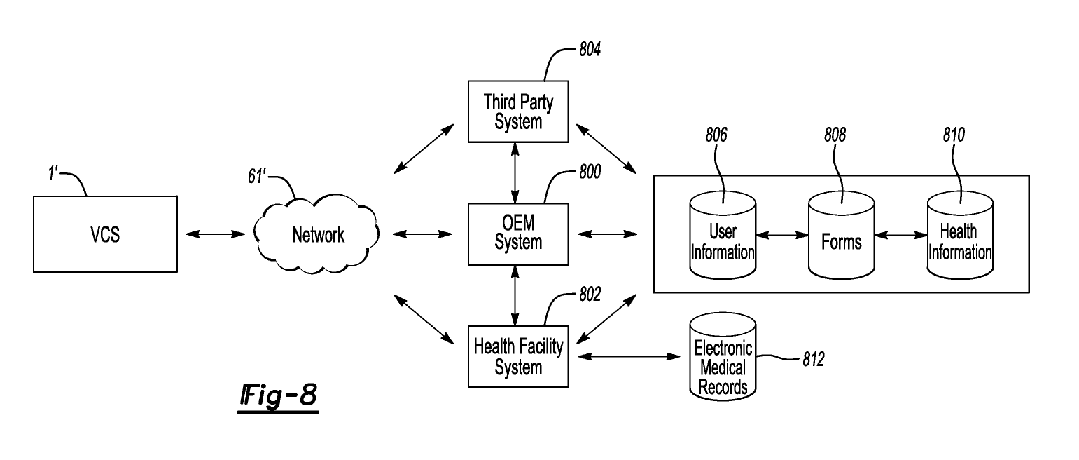

A health profile may also be updated. The update may be performed by the vehicle user and/or the health facility. As an example of the latter, the health profile may be updated manually by a health facility professional. An update flag or other identifier may be associated with the health profile information 810 (FIG. 8) once the update is made identifying that the health information has been updated. In some embodiments, a notification may be sent to the vehicle user that the health profile has been updated. The vehicle user may additionally or alternatively update the health profile from the VCS 1, ND 53, or a remote computing system (not shown) such as (and without limitation) a home computer.

The user and health profile(s) may be stored at the VCS 1 and/or at a remote system accessible via network 61 (block 206). This remote system may be a system operated by the OEM or a third-party service such as GOOGLE HEALTH or MICROSOFT HEALTHVAULT. The user and health profile information may be associated with the user identification information (such as, and without limitation, the username and password, the biometric identifier, a mobile identification number, vehicle identification number, or a combination of identifiers).

More than one vehicle user may use the service. Accordingly, during the registration process, additional vehicle user may be added (block 208). If additional users are added, each user may create and store a user and health profile as described above. In some embodiments, there may be a limited number of vehicle users that may added. If no additional users are being added, an input or other indication may be received that the registration process is complete (block 210).

As part of the preparation process, a patient may be required to fill out various forms (e.g., intake forms), particularly if it is the patient's first visit. As such, a vehicle user/patient may request the health facility to electronically transmit the forms to the user. The health facility may do so through electronic mail or an electronic file transfer which the user may receive while in the vehicle. The health facility may additionally or alternatively provide the user access to a secured site from which to retrieve the appropriate forms.

In some embodiments, the health facilities may also register as partners/associates of the OEM providing this service to vehicle users. Through the business relationship between the health facility and the OEM, the user may be provided with the necessary tools to prepare for a health care facility visit.

FIG. 3 illustrates the registration process for a health care facility when a business relationship is established between the OEM and the health care facility. Once the relationship is established, the service may be enabled for the health care facility (block 300). In some embodiments, the health care facility may have access to a secured system on which the forms may be stored and to which patients may be given access.

The health care facility may create a profile (block 302). The profile may include information such as, and without limitation, name, contact information, services of the health facility, health insurance types accepted, profiles of health professionals at the health care facility, hours of operation, and other like information.

The health facility may designate select individuals to manage the health facility's system (block 304). For example, these individuals may be authorized users to maintain the forms, provide updated forms, receive completed forms, transmit completed forms to the appropriate professionals in the health facility, and transmit unprepared forms to a vehicle user in response to a user request. These individuals may additionally manage and maintain patient medical records. Certainly, the designated individual(s) may be responsible for other tasks as well. Accordingly, it will be appreciated that these examples are non-limiting.

Also during (and/or after) he registration process, the electronic patient forms may be generated/loaded and stored (block 306). The electronic forms may be “fillable” PDF forms or web-based forms (e.g., and without limitation, XML, HTML, and the like). In some embodiments, the forms may be stored in a repository of forms managed by the health care facility. One or more links to these electronic forms may be provided. In addition, updated forms may additionally or alternatively be loaded/generated as described below.

As will be described with respect to FIG. 7 below, a user may need assistance in preparing the form. For example, a user may want to know what information is being sought in one or more inquiries on the form. The health facility may provide descriptions of one or more fields on the form (block 308) which may be presented to the vehicle user when requested. Further details of the assistance process are described below.

Once the forms have been uploaded/generated and/or descriptions provided, the forms and/or descriptions may be stored (block 310) in one or more repositories (not shown). The repositories maybe managed by the automotive OEM, the health care facility, and/or a third-party. In some embodiments, the forms may be organized in the repository according to the services offered by the health facility.

At anytime, the forms may be updated. If the health facility has updated a particular form (block 312), the form generation/upload process may occur as described above. Accordingly, whether or not the form has been updated, the latest version of the form(s) may be made available (block 314).

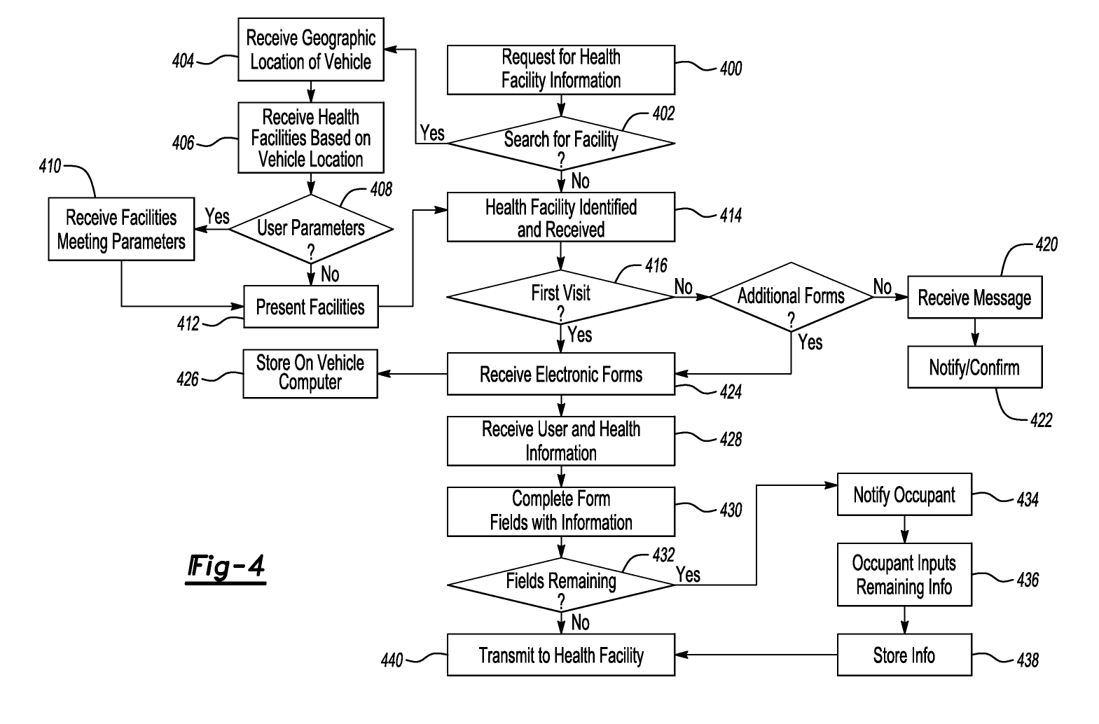

FIG. 4 illustrates the operation at the VCS 1 for preparing a vehicle user for a health facility visit. Health facility information may be requested at the vehicle computer (block 400). Health facility information may include an identification and presentation of one or more health facilities in and/or around the geographic area of the vehicle and/or forms for the one or more health facilities. The request may be received through a spoken command and/or a tactile command (e.g., touchscreen, capacitive, and the like).

A determination may be made if the vehicle user is requesting a search for and identification of one or more health facilities (block 402). The request may be made at the VCS 1 through one or more of an audible command (e.g., using spoken language) and tactile commands. In some embodiments, the request may be made via the navigation system 54, 60. Of course, this determination is not a default determination, but provided for illustration and clarity purposes.

The geographic location of the vehicle may be received based on information from the GPS device 24 (block 404). The health facilities in and/or around the geographic location of the vehicle may be searched and identified. The search may be based on defined search parameters including, but not limited to, a distance from the vehicle, facilities along a destination or travel route, a point-of-interest search, or a combination of search parameters. Once identified, the health facilities may be received at the VCS 1 (block 406).

Some health facilities may not service certain health conditions and/or certain types of patients. Also, a patient may have additional needs/criteria before choosing a health facility for treatment or another service. As one non-limiting example, a patient may desire to go to a facility of a certain quality (e.g., the overall best rated facility, cleanest facility, facility having the most beds, etc.). As another non-limiting example, the patient may additionally or alternatively desire that the health professional be of a certain gender. Accordingly, in some embodiments, the health facilities that are presented in the vehicle may be based on such user parameters (block 408). Such user parameters may be input by the user in the vehicle and/or received from the vehicle user's “user profile”.

The health facilities meeting the user parameters may be received at the VCS 1 (block 410) and presented in the vehicle (block 412). Alternatively, where health facilities do not meet the user parameters and/or no user parameters have been input, the health facilities may be presented based on the search parameters (described above) (block 412). The health facilities may be presented audibly (e.g., from speaker(s) 13) and/or visually (e.g., on display 4).

The health facility may be identified and received at the VCS 1 (block 414). In some embodiments, the vehicle user may predetermine the health facility to visit. Accordingly, the user may input the predetermined health facility. Alternatively or additionally, the predetermined health facility may be received from the user and/or health profile. The user may input the predetermined health facility and/or input instructions to receive the predetermined health facility from the user profile using audible and/or tactile commands. In some embodiments, the health facility may be received from the user and/or health profile automatically.

After a health facility is identified, it may be determined if the vehicle user has visited the facility before (block 416). This determination may be performed in a multitude of non-limiting ways. As one non-limiting example, the VCS 1 may store in memory a history of the vehicle user's visits to health facilities. The visits may be obtained from the navigation system history and/or tracking by the GPS system 24. Additionally or alternatively, the visit history may be stored at a remote system accessible via communication network 61 (e.g., and without limitation, the Internet). As another non-limiting example, a user identified “preferred” health facility (e.g., identified in the user and/or health profile may be considered a previously visited health facility. As another non-limiting example, the user may provide input at the VCS 1 representing that the health facility has been previously visited. As another non-limiting example, the health facility may inform the OEM that the vehicle user has previously visited the health facility (e.g., and without limitation, based on a patient list). Of course, any combination of these methods may also be used to determine if the vehicle user is a first time visitor.

As described above, a part of the patient preparation process may include the preparation of forms requested by the health facility to be completed. Accordingly, if it is not the vehicle user's first visit to the health facility, it may be determined if there are additional forms for the vehicle user to prepare (block 418). These may include, but are not limited to, patient update forms, forms requesting/instructing the vehicle user to provide a reason for the visit, and optional forms that the vehicle user may complete if desired. One non-limiting example of an optional form may ask for the vehicle user's interest or willingness to participate as a subject in research studies.

In some embodiments, this determination may be made even if the vehicle user has never before visited the health facility. In this case, the health facility may have received the vehicle user's patient records from another health facility in preparation for the vehicle user's visit. As a non-limiting example, in a case where the vehicle user may change health facilities, the vehicle user's patient records may be requested and received from the replaced health facility.

A message may be transmitted to the VCS 1 if there are no additional forms or the user does not desire to prepare the forms (block 420). In some embodiments, a notification may also be presented to the vehicle user as confirmation (block 422).

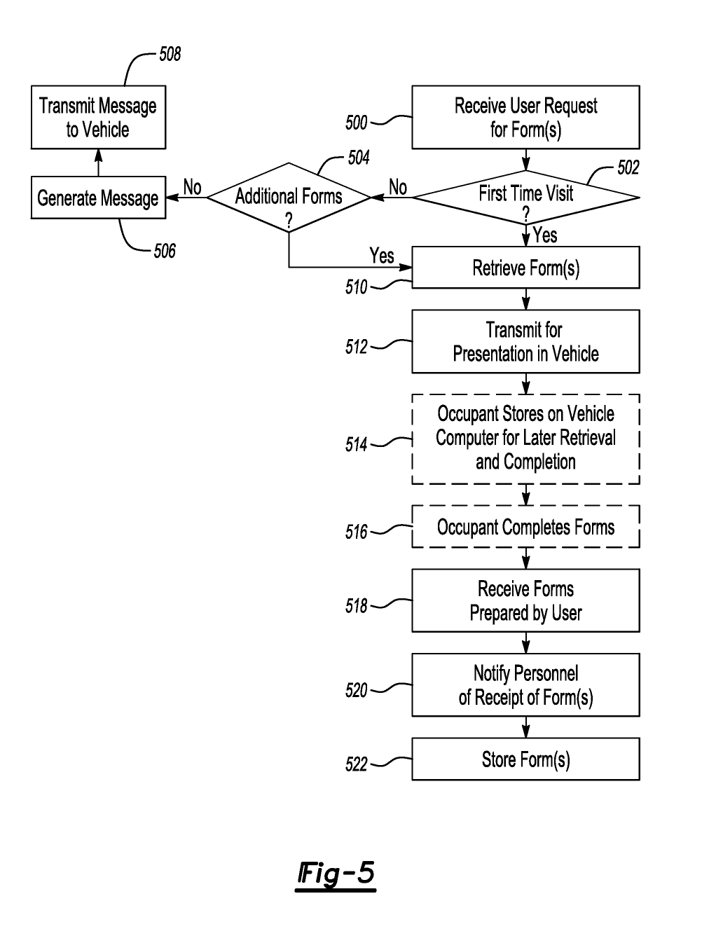

If there are forms for the vehicle user to prepare, the electronic forms from the health facility may be received at the VCS 1 (block 424). Details of the form transmission and receipt process by the health facility will be described in detail below with respect to FIG. 5.

In some cases, the vehicle user may desire to download the forms to the vehicle computer and complete the forms at a later time. Accordingly, the vehicle user may store the received forms in memory of the vehicle computer (block 426). The forms may additionally or alternatively be stored on portable memory (e.g., a USB drive) and/or transmitted wirelessly to a remote computer (e.g., a home computer).

Conveniently, the tool may also automatically complete one or more fields of the form based on information in the user and/or health profiles. The profile information may be stored in one or more databases (FIG. 8). Thus, during the form preparation process, the corresponding information from the database(s) may be retrieved/received by the VCS 1 (block 428) and input to the form field(s) (block 430).

There may be additional fields remaining to be completed even after the information from the profile(s) has been received (block 432). If additional fields remain to be completed, the vehicle user may be notified and requested to complete the form(s) (block 434). The vehicle user may input information to the remaining field using spoken input and/or tactile inputs (block 436).

In some embodiments, the additional information entered by the vehicle user may be stored in one or more of the profile(s) (block 438). Accordingly, in future form preparation events, this information may be made available for automatic form preparation if needed. The information may be stored remotely and/or locally.

The form(s) may be transmitted to the health facility at any time (block 440). In general, the form(s) may be transmitted when complete (to the extent possible). However, some fields may be left blank. In such cases, the vehicle user may or may not complete these fields at a later time (e.g., at the health facility).

The electronic form(s) may be transmitted in response to vehicle based events. Such vehicle based events may be determined from data received from the vehicle network (e.g., and without limitation, a CAN network). Such vehicle based events include, but are not limited to, a key-on, a key-off, a gear shift, button press(es) (including touchscreen button press(es)), input from microphone 29 (e.g., voice based command(s)), and the like. In some embodiments, the vehicle-based events may cause the user information used for preparing the forms to be stored at the vehicle computer 1. In some embodiments, the vehicle-based events may cause the electronic forms to additionally or alternatively be stored.

As described above, the health facility may be responsible for making the forms available to the vehicle user. The operation illustrated in FIG. 5 shows the process for providing the forms made available by the health facility to the vehicle user. The process may occur at one or more computing systems remotely communicating with the vehicle 31 via network 61. The remote computing system may be operated by the health facility and/or the OEM. In some embodiments, at least part of the remote computing systems may be additionally operated by a third-party.

The user request for the form(s) (as described in FIG. 4 above) may be received at the remote system (block 500). As described above, the health facility may have information on whether the visit is a vehicle user's first visit (block 502).

If not, it may be determined if there are additional forms for the vehicle user (block 504). Non-limiting examples of such additional forms are provided above. The search for additional forms may be performed through a manual or automatic search. A message may be generated if there are no additional forms (block 506) and the message transmitted to the vehicle to notify the vehicle user (block 508). It will be appreciated that the message may be a human-readable message (e.g., a text based message) and/or a computer-readable message (e.g., a binary message).

If there are forms to be prepared by the vehicle user, the forms may be retrieved (block 510). In some embodiments, this retrieving process may include retrieving one or more links associated with web-based forms.

The form(s) may be transmitted to the vehicle 31 for presentation in the vehicle 31 (block 512). As represented by the dashed blocks (representing steps occurring in the vehicle 31 described above in FIG. 4), the vehicle user may or may not store the forms on the VCS 1 (block 514). The forms may be prepared in the vehicle 31 before transmission to the health care facility (block 516). The forms may be prepared in free form text, in a multiple choice format, in a yes/no format, in a true/false format, or a combination of such formats.

The form(s) prepared by the vehicle user may be received by the remote computing system (block 518). Personnel at the health facility may be notified that forms from a vehicle user/patient have been received (block 520). The notification may be received as an electronic mail notification, a pop up notification, an audible notification (e.g., a beep or chime), a text-based notification, or a combination of such notifications. Other notification types may be used without departing from the scope of the invention.

In some embodiments, the received form(s) may be stored (block 522). Storing the form(s) may include, but is not limited to, storing in an electronic form repository and/or printing and filing the form(s).

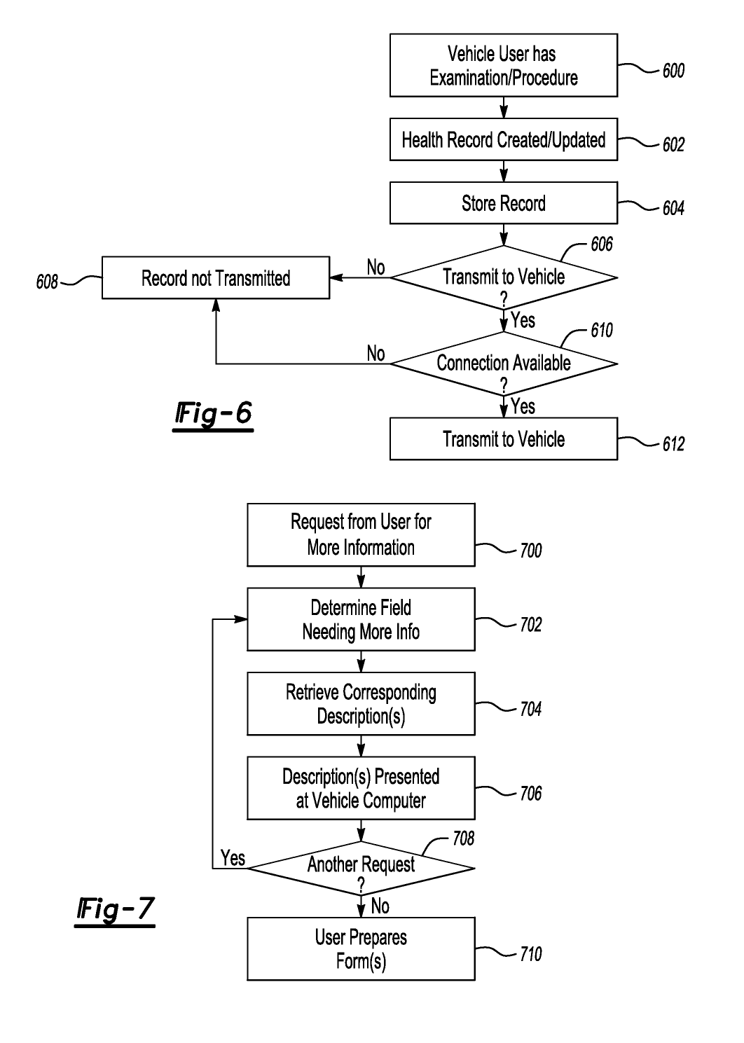

In some embodiments, a vehicle user may request one or more health records from the health care facility. FIG. 6 illustrates the process of providing a vehicle user with one or more requested health records. As illustrated in block 600, the vehicle user/patient has an examination/procedure performed at the health facility. The examination/procedure may occur at any time and not necessarily near the time of the record request.

A health record for the examination/procedure may be created (block 602) and stored (block 604). The health record may be stored in an electronic medical records repository (compliant with applicable government regulations). In some embodiments, the record(s) may additionally be stored in a third-party database or an OEM-operated database. These databases may also comply with applicable government regulations.

A request from the vehicle user may be received for one or more medical record(s) by the system storing the vehicle user's records. The request may include a user identifier. In some embodiments, the request may be received by the health facility.

A determination may be made if a request to transmit the record(s) to the vehicle has been received (block 608). In some embodiments, the request may be received before the examination/procedure. In additional or alternative embodiments, the user may set a preference to receive the record(s) after every visit. Accordingly, the record is not transmitted if a request to transmit to the vehicle has not been received (block 606).

When a request for the record(s) is received, the record(s) may be transmitted (block 612) if a network connection 61 is available with the vehicle (block 610). A network connection may not be available, for example, if the ND 53 is not paired with the VCS 1 or an Internet connection is not available. If a connection is not available, the record may not be transmitted until a connection is established. In some embodiments, the records may be held in a queue and transmitted when a connection is established.

FIG. 7 illustrates the operation when a vehicle user requests assistance during the form preparation process. A request from the vehicle user for more information on one or more fields on the form(s) may be received at the VCS 1 (block 700). The request may be received as a spoken request and/or via one or more button presses (including, but not limited to, on a steering wheel, at the center stack, from a touchscreen display) in the vehicle.

In response to receiving the request, the field(s) for which the vehicle user needs additional assistance may be determined (block 702). The user may input (e.g., through a voice and/or touch-based command) the particular field(s) with which assistance is needed. Additionally or alternatively, the field(s) may be automatically determined. As a non-limiting example, if the user request is received while preparing a particular field, it may be determined that the assistance is requested for that field.

The description(s) for the corresponding field(s) may be received over network 61 (block 704). As described above, these field(s) may be provided by the health facility and stored remotely from the vehicle 31. The descriptions may be presented to the vehicle user in the vehicle from speakers 13 and/or display 4 (block 706). In some embodiments, the description(s) may be converted from text to speech at the VCS 1.

The vehicle user may need assistance for more than one field. Accordingly, if there is another request for assistance (block 708), the field(s) with which the vehicle user requests assistance may be determined (block 702) and the process may continue as described above. Otherwise, the vehicle user may prepare the form without assistance (or further assistance) and transmit to the health facility (block 710).

FIG. 8 is a block topology of the remote system communicating with the VCS 1 that operates to prepare a vehicle user for a health facility visit. Blocks 1′ and 61′ correspond to the blocks 1 and 61 of FIG. 1.

As described above, the VCS 1′ may communicate with one or more remote systems. Non-limiting examples of such remote systems may include an OEM system 800, a health facility system 802 and/or a third-party system 804. Each system may include one or more servers and one or more databases storing user profile information 806, health facility forms 808 and/or health profile information 810. Additionally, the health facility system 802 may include a database storing patient electronic medical records 812.

The location and operation of databases 806, 808 and 810 may be dependent on the entity in charge of the data. In some embodiments, one entity may be in charge of all the information. As a non-limiting example, third-party system 804 may store user profile information 806, forms 808, and health profile information 810. In other embodiments, two or more entities may be in charge of the information. As a non-limiting example, the health facility may be responsible for the forms database 808 while the OEM may be responsible for the user profile database 806 and the health profile database 810. In all embodiments, the systems 800, 802, 804 may communicate with each other as described in the various embodiments above.

While exemplary embodiments are illustrated and described above, it is not intended that these embodiments illustrate and describe all possibilities. Rather, the words used in the specification are words of description rather than limitation, and it is understood that various changes may be made without departing from the spirit and scope of the invention.

What is claimed:

1. A computer-implemented method for preparing a vehicle user for a health care facility visit, the computer-implemented method comprising:
receiving vehicle network data defining one or more vehicle-based events;
receiving at a vehicle computer information identifying a health facility;
based on health facility identifying information, receiving at the vehicle computer data representing one or more electronic patient information records for the health facility;
receiving vehicle user health information for preparing the one or more electronic patient information records;
preparing the one or more electronic patient information records based on the vehicle user health information; and
transmitting the prepared electronic patient information record to the health facility in response to the one or more vehicle-based events based on the vehicle network data.

2. The computer-implemented method of claim 1 further comprising presenting preparation instructions in the vehicle for preparing the electronic patient information record.

3. The computer-implemented method of claim 2 further comprising receiving a user request for the preparation instructions, wherein presenting the preparation instructions is in response to the user request.

4. The computer-implemented method of claim 2 further comprising presenting the preparation instructions in a spoken language.

5. The computer-implemented method of claim 1 further comprising storing the vehicle user information in response to the one or more vehicle-based events based on the vehicle network data.

6. The computer-implemented method of claim 1 further comprising determining if one or more electronic patient information record have been previously received by the health facility, wherein the electronic patient information record is a supplemental electronic patient information record if one or more electronic patient information records have been previously received.

7. The computer-implemented method of claim 1 further comprising receiving vehicle location information, wherein the health facility identifying information is based on the vehicle location information.

8. The computer-implemented method of claim 1 further comprising receiving a user selection of a health facility, wherein the health facility identifying information is based on the user selection of the health facility.

9. A computer program product for preparing a vehicle user for a health care facility visit, the computer program product being embodied in a computer-readable medium and comprising instructions for:
receiving vehicle network data defining one or more vehicle-based events;
presenting at the vehicle computer one or more electronic patient information records for a health facility;
receiving a vehicle user request for preparation instructions for one or more fields of the one or more electronic patient information records for the health facility;
based on the user request, receiving the preparation instructions for the one or more fields;
outputting the preparation instructions at a vehicle computer;
upon outputting the preparation instructions, receiving vehicle user health information for preparing the one or more fields of the one or more electronic patient information records; and
storing the one or more electronic patient information records in response to the one or more vehicle-based events based on the vehicle network data.

10. The computer-program product of claim 9 further comprising instructions for audibly presenting the one or more fields of the electronic form at a vehicle computer.

11. The computer-program product of claim 10 further comprising instructions for presenting the one or more fields audibly and visually.

12. The computer-program product of claim 9 further comprising instructions for:
receiving a geographic location of a vehicle; and
identifying the health facility based on the geographic location of the vehicle.

13. The computer-program product of claim 9 wherein the user health information is stored in memory remote from a vehicle.

14. The computer-program product of claim 13 further comprising instructions for updating the vehicle user health information.

15. The computer-program product of claim 9 further comprising instructions for transmitting the electronic patient information record in response to the one or more vehicle-based events based on the vehicle network data.

16. The computer-program product of claim 9 wherein the vehicle-based events include a key-on, key-off, one or more button presses, one or more inputs from a microphone, or a gear change.

17. A system comprising:
a computer configured to:
receive vehicle network data defining vehicle-based events;
receive a user selected health facility;
output information defining fields of a patient information record for the health facility;
receive preparation instructions for a field;
receive vehicle user information according to the preparation instructions;
prepare the field based on the vehicle user information; and
in response to the vehicle-based events, store the patient information record.

18. The system of claim 17 wherein the computer is further configured to prepare the field automatically based on vehicle user information stored in memory.

19. The system of claim 17 wherein the user-selected health facility is selected based on user-defined parameters regarding the health facility.

20. The system of claim 19 wherein the user-defined parameters is at least one of a type of service, quality of the health facility, or gender of a health professional.
